(19) United States
(12) Patent Application Publication
(10) Pub. No.: US 2025/0281344 A1
(43) Pub. Date: Sep. 11, 2025

(54) CANE FOR THE VISUALLY IMPAIRED HAVING A STAND-UP MOUNT FEATURE

(71) Applicants: Raquel R. Gebel, Wildwood, MO (US); Barclay W. Gebel, Wildwood, MO (US); Stephanie Snow Gebel, Wildwood, MO (US)

(72) Inventors: Raquel R. Gebel, Wildwood, MO (US); Barclay W. Gebel, Wildwood, MO (US); Stephanie Snow Gebel, Wildwood, MO (US)

(21) Appl. No.: 19/058,263

(22) Filed: Feb. 20, 2025

Related U.S. Application Data
(60) Provisional application No. 63/562,074, filed on Mar. 6, 2024.

(51) Int. Cl. A61H 3/06

(52) U.S. Cl. CPC A61H 3/068; A61H 2201/0119; A61H 2201/0161; A61H 2201/1418

(57) ABSTRACT

A cane comprises a pole structure and a stand-up mount. The pole structure has a handle and a tip. The stand-up mount has at least three legs that transition between a retracted position and an engaged position. The legs are nearer to the pole structure in the retracted position. The legs extend outwardly from the pole structure in the engaged position to permit the cane to stand upright on its own. The stand-up mount can be manually activated or it can include a battery-powered actuator to be automatically activated by the user.

### RELATED APPLICATIONS

This application claims priority to and the benefit of U.S. Provisional Application No. 63/562,074, filed on Mar. 6, 2024, which is incorporated herein by reference in its entirety.

### TECHNICAL FIELD

This disclosure relates generally to canes for the visually impaired and, more specifically, to a stand-up feature that allows the cane to stand in an upright position by itself.

### BACKGROUND

It is common for individuals who are the visually impaired to use a cane to assist with navigation when walking. Most canes are typically between 4 feet and 5 feet in length, although they can be shorter or longer to best suit the height of the individual. Canes have a handle on one end and an opposing tip on the other end. The tip often includes a larger, rounded portion.

When the individual needs to use both hands or even when sitting at a table, he or she often leans the cane against the table, a wall, or a chair. The problem is that a leaning cane often results in the cane falling to the floor. Therefore, there is a need for an improved cane that allows the individual to maintain the cane in a stand-up position without the concern of the cane falling to the ground.

### SUMMARY

Embodiments of the invention concern a stand-up mount feature for a cane that is operated by a user having a visual impairment. The stand-up mount feature can be retrofitted to an existing cane, or it can be a permanent feature of a cane. The stand-up mount feature can be fixed to the tip end or the handle end.

In a first embodiment, the cane comprises a pole structure and a stand-up mount. The pole structure has a handle and a tip. The stand-up mount has at least three legs that transition between a retracted position and an engaged position. The legs are nearer to the pole structure in the retracted position. The legs extend outwardly from the pole structure in the engaged position to permit the cane to stand upright. The stand-up mount is affixed to the region of the pole structure near the tip or near the handle.

In another embodiment, a method of maintaining a cane in an upright position comprises (i) moving at least three legs of a stand-up mount feature on the cane from a retracted position to an engaged position, wherein the legs extend outwardly from the pole structure in the engaged position, and (ii) adjusting an orientation of the cane to the upright position in which the at least three legs are contacting the floor or the ground.

### BRIEF DESCRIPTION OF THE DRAWINGS

Disclosed herein are embodiments of systems, apparatuses, and methods pertaining to vehicle imaging systems with an enhanced lighting feature. This description includes drawings, wherein:

FIG. 1A is a known cane in a folded state;

FIG. 1B is the cane of FIG. 1A in an operational state;

FIG. 1C is an alternative known cane having a different tip configuration;

FIG. 2A is an image of the cane of FIGS. 1A-1B that includes one embodiment of a stand-up mount;

FIG. 2B is an enlarged view of the stand-up mount in FIG. 2A in the engaged position;

FIG. 3 is an enlarged view of the stand-up mount in FIGS. 2A-2B in a retracted position;

FIG. 4 is a side view of one of the arms of the stand-up mount; and

FIG. 5 is a schematic side view of the stand-up mount illustrating the transition from the retracted position to the engaged position.

FIG. 6 illustrates the stand-up mount in the engaged position when affixed to the handle end of the cane in FIG. 1C.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

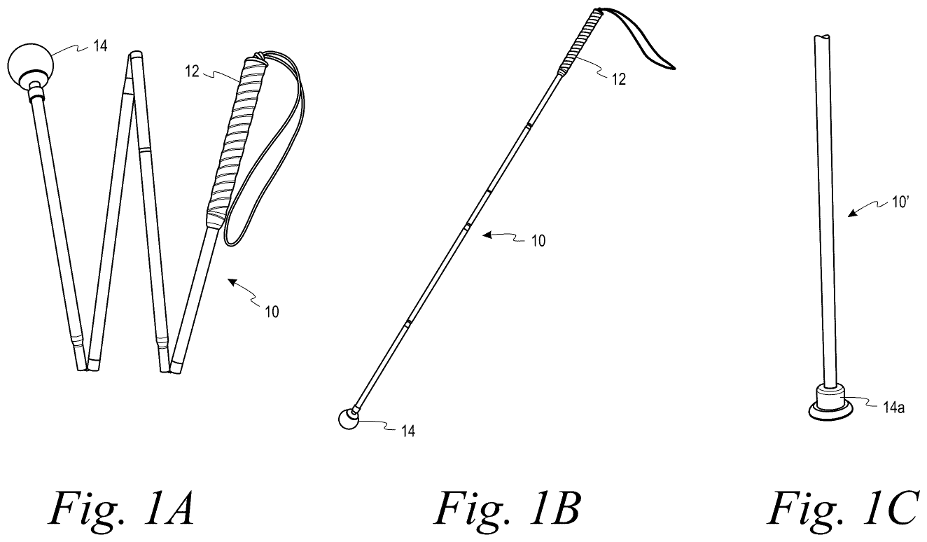

FIGS. 1A-1B illustrate one type of known cane 10 that is used by an individual who is visually impaired. Many prior art canes, like the cane 10, can be folded to reduce the overall size, as shown in FIG. 1A. FIG. 1B illustrates the cane 10 in an operational state. The cane 10 includes a handle 12 and a tip 14 and a single pole structure extending between the handle 12 and the tip 14. The tip 14 can be in various configurations, including the rounded tip 14 shown in the FIGS. 1A and 1B. Alternatively, the tip can include a flatter configuration, such as the tip 14a of the alternative cane 10′ in FIG. 1C. In summary, the stand-up mount feature of the present invention can be used on various types of canes 10 having different configurations for the tip, including canes that can be folded as shown in FIGS. 1A-1B.

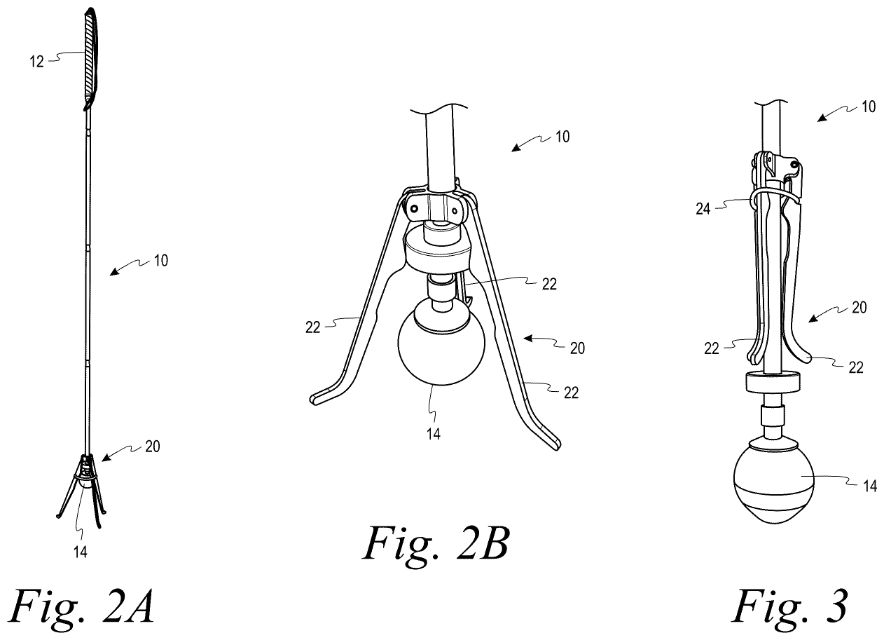

FIGS. 2A-2B illustrate the cane 10 with a stand-up mount 20 affixed to the pole structure adjacent to the tip 14. The stand-up mount 20 allows the cane 10 to stand on its own without any balancing forces applied to the cane 10 by the user or an adjacent structure, such as a chair, wall, or table. As shown best in FIG. 2B, the stand-up mount 20 includes at least three legs 22 that are positioned around the tip 14, preferably in a symmetrical arrangement (here at 120° apart). In the engaged position of FIG. 2B, the three legs 22 extend downwardly below the tip 14 to engage the floor or the ground.

FIG. 3 illustrates the stand-up mount 20 in the retracted position in which the lowermost ends of the legs 22 are positioned above the tip 14. In the retracted position, the legs 22 are located above the tip 14 such that they do not interfere with the normal operation of the cane 10 when the tip 14 is used to help the user navigate around his or her surroundings. The function and operation related to the retraction and extension of the stand-up mount 20 are described in more detail below relative to FIG. 5.

FIG. 3 also illustrates a biasing element 24 that works with legs 22 to hold them in a position against the cane 10. As shown in FIG. 3, the biasing element 24 is an elastic band that wraps around the three legs 24 to maintain them in the retracted position. In one embodiment, the biasing element 24 provides between about 1-6 pounds of force. In alternative embodiment, the biasing element 24 can be in the form of one or more springs. As one exemplary embodiment, the stand-up mount 20 may include three different springs, wherein each of the three springs is used to connect two adjacent ones of the three legs 22 to pull them together. Alternatively, each spring could be connected a leg and a central mounting ring of the stand-up mount 2 to bias the legs inwardly.

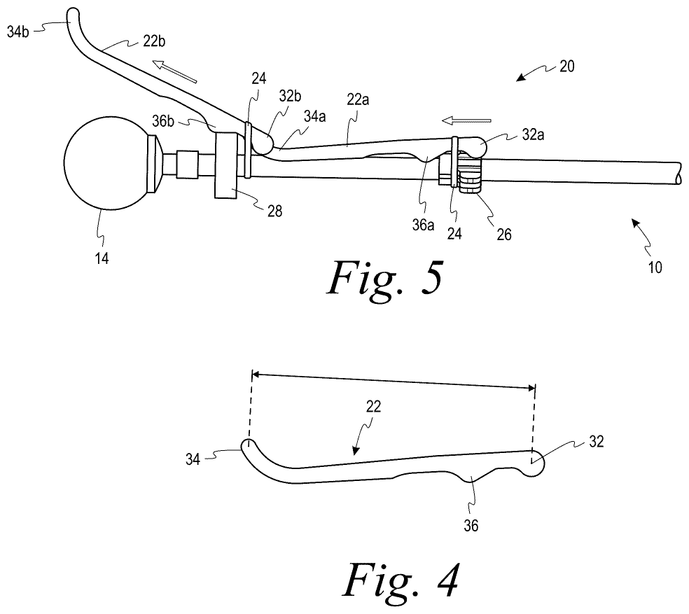

FIG. 4 illustrates one possible configuration for the leg 22 of the stand-up mount 20. The leg 22 includes an actuator portion 32 that moves along the longitudinal axis of the cane 10. At the opposing end, the leg 22 includes a foot portion 34 that is designed to engage the floor or ground. A cam portion 36 is located along the length of the leg 22 and between the actuator portion 32 and the foot portion 34.

FIG. 5 illustrates one of three legs 22 transitioning between a retracted position (where the leg 22 and its structures are denoted with the suffix “a”) and an engaged position (where the leg 22 and its structures are denoted with the suffix “b”). The actuator portion 32 of the leg 22 is fixed to a sliding member 26 that can move downwardly and upwardly along the cane 10. As the user pushes the sliding member 26 downwardly, the foot portion 34a of each leg 22a moves downwardly and outwardly against the force of the biasing element 24 as the leg 22a slides against a stop member 28 located on the cane 10 near the tip 14. At its lowermost position, the leg 22b is in the engaged position whereby the foot portion 34b extends below the lowermost portion of the tip 14 and the cam portion 36b is positioned against the stop member 28. In the engaged position, the shape of the cam portion 36b allows the leg 22b to be held tightly against the stop member 28 under the force of the biasing element 24. Alternatively, the cam portion 36 can include a hook-shaped lower end that fits around and engages the lowermost surface of the stop member 28. With the force of the biasing element 24 pulling the legs 22b inwardly such that cam portions 36b are in tight engagement with the stop member 28, the cane 10 can stand under the support of the legs 22 alone. As such, in the engaged position, the legs 22b are capable of supporting the cane 10 in a vertical, stand-up position, such that, when the cane 10 is not in use, the user does not need to lean the cane 10 against a table, chair or wall to keep it upright, mitigating the risk of the cane 10 falling to the floor. In alternative arrangement, the sliding member 26 can have snap features that engage corresponding features on the stop element 28 to hold the legs 22 in place.

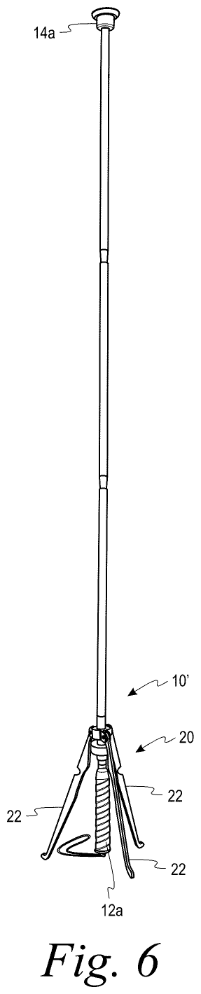

FIG. 6 illustrates the stand-up mount 20 attached to the cane 10′ of FIG. 1C adjacent to the handle 12a. When the stand-up mount 20 is attached in this manner, the tip end 14a of the cane 10′ sticks upwardly. This arrangement of FIG. 6 may be more suitable in some situations. For example, if the user wants less weight at the tip end 14a during operation to provide more sensitivity to the cane 10′, then placing the stand-up mount 20 near the handle 12a may permit that additional sensitivity. In the embodiment of FIG. 6, the stand-up mount 20 is completely surrounding the pole structure of the cane 10′ below the handle 12a when in the retracted position. Alternatively, the legs 22 can be rest against a lowermost portion of the handle 12a when in the retracted position. In some embodiments, the cam structure 36 of the stand-up mount 20 engages and is forced against the wider diameter portion of the handle 12a when the stand-up mount 20 is in the engaged position instead of the stop element 28, thereby eliminating the need for the stop element 28. Although the handle cord at the end of the handle 12a is shown as being on the floor in FIG. 6, the stand-up mount 20 may include a hook, protrusion or recess that receives the handle cord to allow the handle cord to be hung upwardly away from the floor.

The stand-up mount 20 also serves a notification function when maintaining the cane 10 in the upright position because other people in the vicinity understand the user is visually impaired. In known canes, the user would lean them against surfaces (e.g., a chair or a wall), which are not completely visible by other people. Alternatively, the user may have folded a known cane and kept it on an adjacent chair or table. However, when the user has a cane with the stand-up mount 20, the stand-up mount 20 allows the cane 10 to be in an upright position immediately adjacent to him or her, such that it becomes obvious to other people that the user is visually impaired. This notification function is especially useful when the user is located within a crowded area, such as a restaurant when the user is being served by a waiter or waitress.

When the user requires the cane 10 for navigating, he or she grabs the up-right cane 10, slides his or her hand toward the tip 14, and pulls the sliding member 26 upwardly toward the handle so the legs 22b are then moved back over the stop member 28 with the urging force of the biasing member 24. Eventually, the legs 22a are in the retracted position and positioned against the cane 10, such that the user can begin using the cane 10.

In one embodiment, the stand-up mount 20 is retrofitted to any type or style of cane 10 to permit the stand-up functionality. In those situations, the sliding member 26 and the stop member 28 are created with multiple pieces to allow them to fit around and lock (e.g., snap-fit) together. Alternatively, the sliding member 26 and the stop member 28 can have a slot in them for receiving pole-like structure of the cane 10, and separate locking members hold them on the cane 10.

In other embodiments, the cane 10 includes the stand-up mount 20 as an original permanent feature. In this instance, the stand-up mount 20 can be manually actuated, as discussed previously, or automatically actuated. For example, the bottom of the cane 10 can include one or more battery-operated linear actuators to pull or push the legs 22 between the engaged position and the retracted position. The cane 10 may include a button that, when activated, causes the stand-up mount 20 to transition between the retracted position and the engaged position under the force of the actuator(s). In one embodiment, the uppermost portion of the rounded tip 14 can include the actuator and battery that transitions the legs 22 of the stand-up mount 20 between the retracted position and the engaged position.

In a further embodiment, an existing cane 10 is retrofitted with a new tip that incorporates the stand-up mount 20. In other words, the user removes the existing tip 14 of the cane 10 and adds the retrofit tip assembly that includes a new tip along with the stand-up mount 20.

While various examples of the present disclosure have been described above, it should be understood that they have been presented by way of example only, and not limitation. Numerous changes to the disclosed examples can be made in accordance with the disclosure herein without departing from the spirit or scope of the disclosure. Thus, the breadth and scope of the present disclosure should not be limited by any of the above-described examples. Rather, the scope of the disclosure should be defined in accordance with the following claims and their equivalents.

Although the disclosure has been illustrated and described with respect to one or more implementations, equivalent alterations and modifications will occur to others skilled in the art upon the reading and understanding of this specification. In addition, while a particular feature of the disclosure may have been disclosed with respect to only one of several implementations, such feature(s) may be combined with one or more other features of the other implementations as may be desired and advantageous for any given or particular application.

The terminology used herein is for the purpose of describing particular examples only and is not intended to be limiting of the disclosure. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this disclosure belongs. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

What is claimed is:

1. A cane for a user having a visual impairment, comprising:
a pole structure having a handle and a tip; and
a stand-up mount having at least three legs that transition between a retracted position and an engaged position, wherein the legs are nearer to the pole structure in the retracted position, wherein the legs extend outwardly from the pole structure in the engaged position to permit the cane to stand upright.

2. The cane of claim 1, wherein the stand-up mount is retrofitted to the pole structure of the cane.

3. The cane of claim 1, wherein the stand-up mount is permanently fitted to the pole structure of the cane.

4. The cane of claim 1, wherein the stand-up mount includes a sliding member that slides along the pole structure, the sliding member being coupled to the legs to transition the legs between the retracted position and the engaged position.

5. The cane of claim 4, wherein the stand-up mount includes a stop member for engaging the legs when the legs are in the engaged position.

6. The cane of claim 5, wherein each of the legs includes a cam portion for locking against the stop member when the legs are in the engaged position.

7. The cane of claim 6, wherein the stand-up mount includes a biasing element to provide a force that helps to pull the cam portions of the legs against the stop member.

8. The cane of claim 1, wherein the stand-up mount includes a biasing element to urge the legs into the retracted position or the engaged position.

9. The cane of claim 1, wherein the transition between the retracted position and the engaged position is in response to the user moving a portion of the stand-up mount.

10. The cane of claim 1, wherein the transition between the retracted position and the engaged position is in response to the user activating a battery-powered actuator.

11. The cane of claim 1, wherein the stand-up mount is affixed to the pole structure adjacent to the tip.

12. The cane of claim 1, wherein the stand-up mount is affixed to the pole structure adjacent to the handle.

13. The cane of claim 12, wherein the stand-up mount includes a sliding member that slides along the pole structure, the sliding member being coupled to the legs to transition the legs between the retracted position and the engaged position around the handle.

14. The cane of claim 13, wherein the stand-up mount includes a stop member for engaging the legs when the legs are in the engaged position.

15. The cane of claim 14, wherein each of the legs includes a cam portion for locking against the stop member when the legs are in the engaged position.

16. The cane of claim 15, wherein the stand-up mount includes a biasing element to provide a force that helps to pull the cam portions of the legs against the stop member.

17. The cane of claim 13, wherein each of the legs includes a cam portion for locking against a wider portion of the handle when the legs are in the engaged position.

18. The cane of claim 17, wherein the stand-up mount includes a biasing element to provide a force that helps to pull the cam portions of the legs against the wider portion of the handle.

19. The cane of claim 18, wherein the biasing element is an elastic band that wraps around the legs.

20. A method of maintaining a cane in an upright position, comprising:
moving at least three legs of a stand-up mount feature on the cane from a retracted position to an engaged position, wherein the legs extend outwardly from the pole structure in the engaged position; and
adjusting an orientation of the cane to the upright position in which the at least three legs are contacting the floor to support the cane in the upright position.
